(19) United States
(12) Patent Application Publication
(10) Pub. No.: US 2023/0223805 A1
(43) Pub. Date: Jul. 13, 2023

(54) ROTOR AND ROTARY ELECTRIC MACHINE

(71) Applicant: TOYOTA JIDOSHA KABUSHIKI KAISHA, Toyota-shi (JP)

(72) Inventors: Toshinori OKOCHI, Toyota-shi (JP); Jianing DENG, Toyota-shi (JP)

(73) Assignee: TOYOTA JIDOSHA KABUSHIKI KAISHA, Toyota-shi (JP)

(21) Appl. No.: 18/060,727

(22) Filed: Dec. 1, 2022

(30) Foreign Application Priority Data
Jan. 12, 2022 (JP) 2022-003046

(51) Int. Cl. H02K 1/276

(52) U.S. Cl. CPC H02K 1/276; H02K 2213/03

(57) ABSTRACT

A rotor includes a rotor core in which magnet mounting holes, which are provided in layers along a radial direction and are arranged symmetrically in a circumferential direction about a d-axis, are formed, and magnets disposed in the magnet mounting holes, wherein the rotor core includes a first bridge portion provided between first magnet mounting holes adjacent to each other across the d-axis, a second bridge portion provided between second magnet mounting holes located further inward than the first magnet mounting holes in the radial direction and adjacent to each other across the d-axis, and third and fourth bridge portions provided between an outer peripheral surface of the rotor core and the first and second magnet mounting holes, respectively, and when smallest widths of the first to fourth bridge portion are L1, L2, L3, and L4, respectively, a relationship of L3<L1<L4<L2 is satisfied.

### CROSS-REFERENCE TO RELATED APPLICATION

This application is based upon and claims the benefit of priority of the prior Japanese Patent Application No. 2022-003046, filed on Jan. 12, 2022, the entire contents of which are incorporated herein by reference.

### FIELD

The present disclosure relates to a rotor and a rotary electric machine.

### BACKGROUND

In an embedded magnet type rotary electric machine in which permanent magnets are embedded in a rotor to form magnetic poles, the combined torque of the magnet torque generated by the permanent magnets and the reluctance torque generated based on the magnetic anisotropy of the rotor core is output torque. Conventionally, in order to increase the output torque, a technique has been proposed in which permanent magnets are arranged in a plurality of layers along the radial direction of the rotor as disclosed in, for example, International Publication No. 2020/057847 (Patent Document 1) and Japanese Patent Application Publication No. 2020-137139 (Patent Document 2).

### SUMMARY

The rotary electric machine in which permanent magnets are arranged in a plurality of layers along the radial direction of the rotor can increase the output torque. However, magnet mounting holes for disposing the permanent magnets therein are provided in the rotor core, and stress concentration due to centrifugal force caused by the rotation of the rotor occurs in the bridge portions formed between the magnet mounting holes. The centrifugal force that causes stress concentration increases as the rotation speed of the rotor increases. Therefore, in order to increase the rotational speed of the rotor in the conventional rotary electric machine, there is room for improvement in the mechanical strength of the rotor of rotary electric machines including the rotary electric machines disclosed in Patent Documents 1 and 2.

Therefore, an object of the present disclosure is to provide a rotor having mechanical strength strong enough for high-speed rotation of a rotary electric machine.

In one aspect of the present disclosure, there is provided a rotor that is rotatably and concentrically disposed inside a stator and in which a plurality of magnetic poles arranged in a circumferential direction with a q-axis interposed therebetween are formed, the rotor including: a rotor core in which magnet mounting holes, which are provided in a plurality of layers along a radial direction and are arranged symmetrically in the circumferential direction about a d-axis, are formed for each of the magnetic poles; and magnets disposed in the magnet mounting holes, respectively, wherein the rotor core includes a first bridge portion, a second bridge portion, a third bridge portion, and a fourth bridge portion, where the first bridge portion is provided between a pair of first magnet mounting holes, which are included in the magnet mounting holes and are adjacent to each other across the d-axis, the second bridge portion is provided between a pair of second magnet mounting holes, which are located further inward than the pair of first magnet mounting holes in the radial direction and are adjacent to each other across the d-axis, the third bridge portion is provided between an outer peripheral surface of the rotor core and the first magnet mounting hole, and the fourth bridge portion is provided between the outer peripheral surface of the rotor core and the second magnet mounting hole, and wherein when a smallest width of the first bridge portion is represented by L1, a smallest width of the second bridge portion is represented by L2, a smallest width of the third bridge portion is represented by L3, and a smallest width of the fourth bridge portion is represented by L4, a relationship of L3<L1<L4<L2 is satisfied.

In the above rotor, the rotor core may further satisfy a relationship of 3.0≤L2/L1≤3.5.

In the above rotor, the rotor core may further satisfy a relationship of 1.5≤L2/L4≤2.2.

In the above rotor, in one of the magnetic poles, the first magnet mounting holes may be provided symmetrically in the circumferential direction about the d-axis across the first bridge portion through which the d-axis passes, and at least one of the magnets may be disposed in each of the first mounting holes.

In the above rotor, in one of the magnetic poles, the second magnet mounting holes may be provided symmetrically in the circumferential direction about the d-axis across the second bridge portion through which the d-axis passes, and at least one of the magnets may be disposed in each of the second magnet mounting holes.

In the above rotor, two or more of the magnets may be disposed in each of the second magnet mounting holes.

In the above rotor, magnets having different dimensions when viewed in an axial direction may be disposed in the second magnet mounting holes.

In the above rotor, in one of the magnetic poles, each of the second magnet mounting holes may have a polygonal line shape having one or more bending points when viewed in the axial direction, and at least one of the magnet may be provided in each of regions on both sides of the bending points.

In the above rotor, the magnets may have a curved shape when viewed in the axial direction.

In another aspect of the present disclosure, there is provided a rotary electric machine including the above rotor.

### BRIEF DESCRIPTION OF THE DRAWINGS

FIG. 1 is a schematic configuration diagram schematically illustrating a rotary electric machine including a rotor in accordance with an embodiment;

FIG. 2 is a cross-sectional view of a rotary electric machine including the rotor according to the embodiment;

FIG. 3 is a cross-sectional view of the rotor according to the embodiment;

FIG. 4 is an explanatory view schematically illustrating the flow of the main magnetic flux in the rotor of the embodiment;

FIG. 5 is a schematic explanatory view illustrating the flow of magnet magnetic flux in the rotor of the embodiment;

FIG. 6 is an enlarged explanatory view illustrating the periphery of a portion forming one magnetic pole in the rotor core included in the rotor of the embodiment;

FIG. 7 is a graph illustrating a relationship between a rotor rotation speed and stress due to centrifugal force;

FIG. 8 is a schematic view illustrating a stress distribution in a rotor core included in a rotor subjected to stress analysis;

FIG. 9 is an explanatory view schematically illustrating leakage magnetic flux in the rotor;

FIG. 10 is a graph illustrating a relationship among an L1/L2 ratio, the maximum stress in the rotor core, and the maximum torque generated by the rotary electric machine;

FIG. 11 is a graph illustrating a relationship among an L2/L4 ratio, the maximum stress in the rotor core, and the maximum torque generated by the rotary electric machine;

FIG. 12 is an enlarged explanatory view of a portion forming one magnetic pole in a rotor in accordance with a first variation;

FIG. 13 is an enlarged explanatory view of a portion forming one magnetic pole in a rotor in accordance with a second variation; and

FIG. 14A is an explanatory view illustrating a magnet having a rectangular shape when viewed in the axial direction, and FIG. 14B is an explanatory view illustrating a magnet having a curved shape when viewed in the axial direction.

### DETAILED DESCRIPTION

Hereinafter, embodiments of the present disclosure will be described with reference to the accompanying drawings. However, in the drawings, the dimensions, ratios, and the like of the respective portions may not be illustrated so as to completely coincide with actual ones. In addition, details may be omitted in some drawings.

### EMBODIMENT

[Configuration of Rotary Electric Machine]

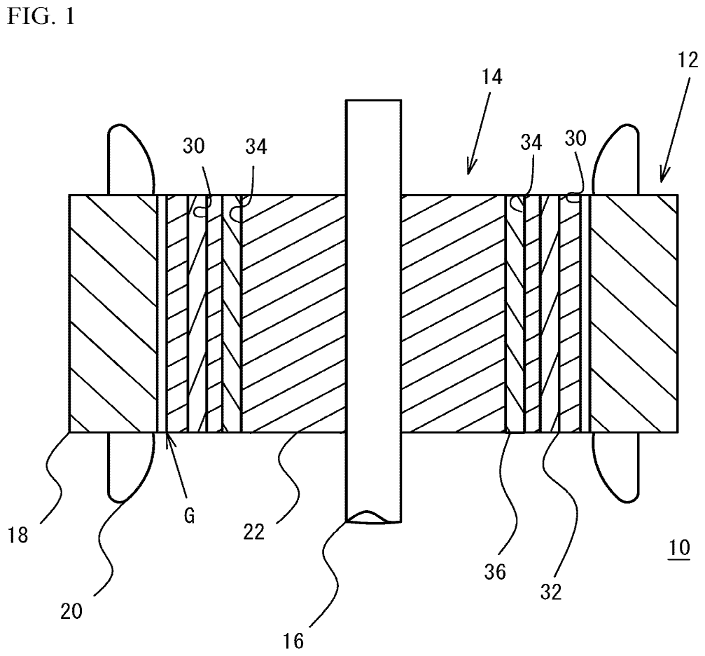

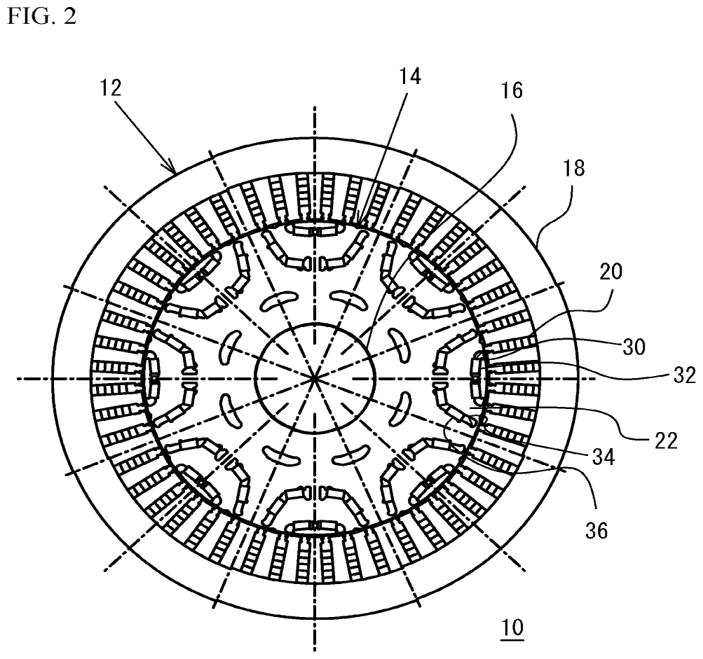

FIG. 1 and FIG. 2 schematically illustrate a rotary electric machine 10 including a rotor 14 in accordance with an embodiment. The rotary electric machine 10 is a permanent magnet synchronous rotary electric machine in which outer magnets 32 and inner magnets 36, both of which are permanent magnets, are embedded in a rotor core 22, that is, a so-called interior permanent magnet (IPM) motor. The rotary electric machine 10 is used as, for example, an electric motor, a generator, or a motor generator having both functions of an electric motor and a generator. The rotary electric machine 10 is used, for example, as a traveling motor or a motor generator of a hybrid vehicle in which an engine and a traveling motor are mounted as drive sources of the vehicle, an electric vehicle, or an electric-powered vehicle such as a fuel cell vehicle. In the following description, the “axial direction”, the “radial direction”, and the “circumferential direction” mean the axial direction of the rotor, the radial direction of the rotor, and the circumferential direction of the rotor, respectively.

The rotary electric machine 10 includes a substantially cylindrical stator 12, the rotor 14 disposed concentrically inside the stator 12, and a rotating shaft 16 fixed to the center of the rotor 14. The stator 12 includes a substantially cylindrical stator core 18 having a plurality of teeth (not illustrated) formed on the inner periphery thereof, and stator coils 20 wound around the respective teeth. A gap G having a substantially uniform distance is formed between the outer peripheral surface of the rotor 14 and the inner peripheral surface of the stator 12.

In the present embodiment, the stator 12 has three phases: a U phase, a V phase, and a W phase, and the stator coil 20 is wound by distributed winding (not illustrated). The stator core 18 is provided with 24 slots in the circumferential direction, and coils are arranged in the respective slots. That is, the rotary electric machine 10 of the present embodiment forms a 24-slot 8-pole motor.

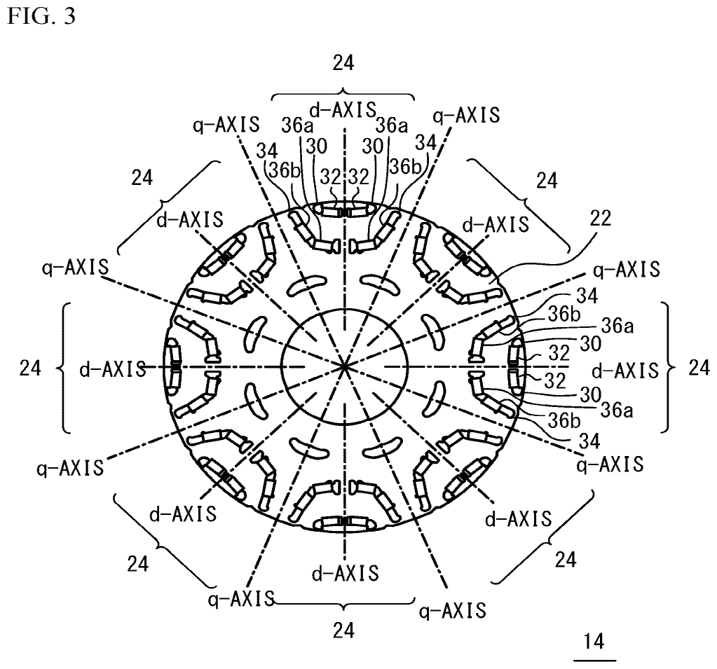

In the rotor 14, magnetic poles 24 (see FIG. 3) are formed by the substantially cylindrical rotor core 22 and the outer magnets 32 and the inner magnets 36 embedded in the rotor core 22. The rotating shaft 16 is fixed to the center of the rotor core 22, and the rotating shaft 16 is supported by a bearing (not illustrated) and rotates together with the rotor 14. The rotor core 22 is formed of an electromagnetic steel plate.

As illustrated in FIG. 3, the rotor 14 is formed with an even number (eight in FIG. 3) of the magnetic poles 24 arranged at equal intervals in the circumferential direction with the q-axis interposed therebetween. The polarities of the even number of the magnetic poles 24 are alternately reversed in the circumferential direction. In the rotor core 22 included in the rotor 14, first magnet mounting holes 30 and second magnet mounting holes 34 that are provided in a plurality of layers in the radial direction and are located symmetrically in the circumferential direction about the d-axis are provided for each magnetic pole 24. One outer magnet 32 is disposed in each of the first magnet mounting holes 30 located in the outer side of the rotor core 22. On the other hand, inner magnets 36a and 36b are disposed in each second magnet mounting hole 34 located in the inner side of the rotor core 22, that is, located further inward than the corresponding first magnet mounting hole 30 in the radial direction. In the present embodiment, two layers of magnet mounting holes are provided in the radial direction, but the number of layers may be three or more.

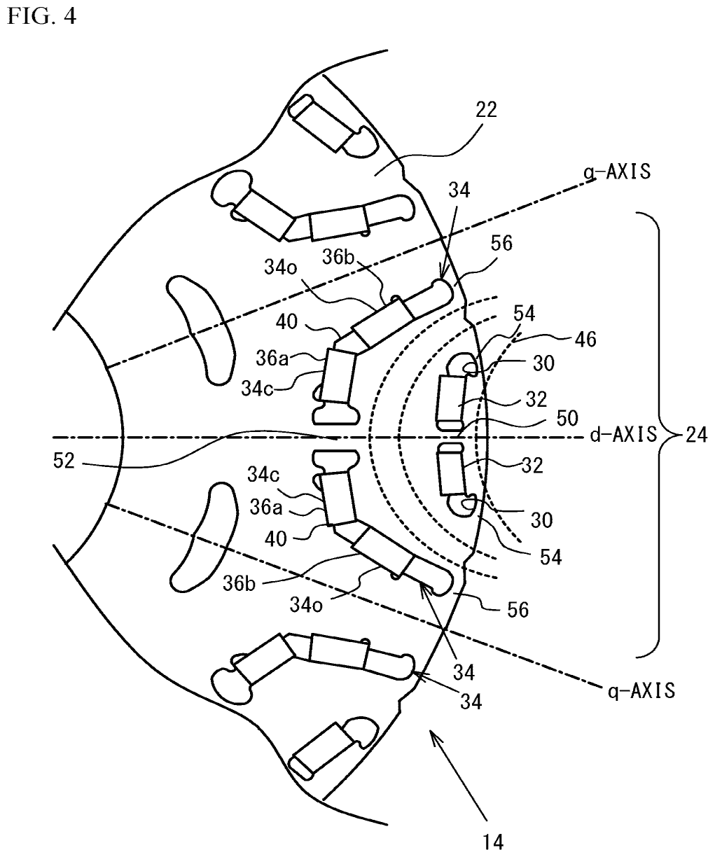

The first magnet mounting holes 30 are arranged symmetrically in the circumferential direction about the d-axis in each magnetic pole, and each first magnet mounting hole 30 is a hole penetrating through the rotor core 22 in the axial direction. Each of the first magnet mounting holes 30 has a substantially rectangular outer shape elongated in one direction when viewed in the axial direction. Each first magnet mounting hole 30 is inclined so as to be farther from the d-axis at closer distances to the outer peripheral edge of the rotor 14, whereby the two first magnet mounting holes 30 form a substantially V-shape as illustrated in FIG. 4. A first bridge portion 50, which is a part of the rotor core 22, is provided between the two first magnet mounting holes 30. The first bridge portion 50 will be described in detail later.

Similarly to the first magnet mounting hole 30, each outer magnet 32 has a substantially rectangular outer shape when viewed in the axial direction. Each outer magnet 32 is magnetized in its thickness direction (the short axis direction). The dimension of the outer magnet 32 in the width direction (the long axis direction) is sufficiently smaller than the dimension of the first magnet mounting hole 30 in the width direction. Therefore, when the outer magnet 32 is mounted in the first magnet mounting hole 30, gaps are formed at both sides of the outer magnet 32 in the width direction. This gap functions as a flux barrier that inhibits the flow of magnetic flux.

The second magnet mounting holes 34 are located further in than the first magnet mounting holes 30 in the radial direction, and a pair of the second magnet mounting holes 34 arranged symmetrically in the circumferential direction about the d-axis are provided so as to form a substantially V shape or a substantially U shape. Similarly to the first magnet mounting holes 30, each second magnet mounting hole 34 is a hole that penetrates through the rotor core 22 in the axial direction. However, the second magnet mounting hole 34 has an outer shape of a polygonal line shape having one or more bending points 40 when viewed in the axial direction. More specifically, the second magnet mounting hole 34 of the present embodiment has a substantially V-shaped outer shape having a center-side portion 34c extending from the bending point 40 toward the center of the magnetic pole 24 and an outer-side portion 34o extending from the bending point 40 toward the outer peripheral edge of the rotor 14. A second bridge portion 52, which is a part of the rotor core 22, is provided between the two second magnet mounting holes 34. The second bridge portion 52 will be described in detail later.

Two inner magnets 36 are mounted in the second magnet mounting hole 34. The two inner magnets 36 are disposed at both sides of the bending point 40. That is, the inner magnet 36a is mounted in the center-side portion 34c of the second magnet mounting hole 34, and the inner magnet 36b is mounted in the outer-side portion 34o. Similarly to the outer magnets 32, the inner magnets 36a and 36b also have a substantially rectangular outer shape when viewed in the axial direction, and are magnetized in its thickness direction (the short axis direction).

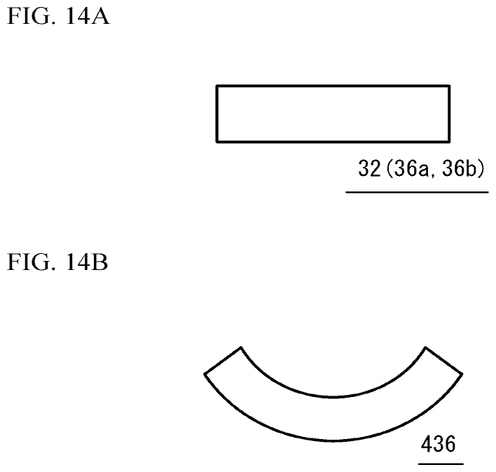

FIG. 14A illustrates the shapes of the outer magnet 32 and the inner magnet 36 when viewed in the axial direction, but instead of such a substantially rectangular shape, a magnet 436 having a curved shape when viewed in the axial direction illustrated in FIG. 14B may be used. Further, the outer magnet 32 and the inner magnet 36 in the present embodiment have the same shape and the same volume, and the outer magnet 32 and the inner magnet 36 have the same composition and the same characteristics. However, magnets having different shapes and volumes may be adopted for respective positions where the permanent magnets are disposed. In addition, magnets having different compositions and different characteristics may be adopted for respective positions where the permanent magnets are disposed.

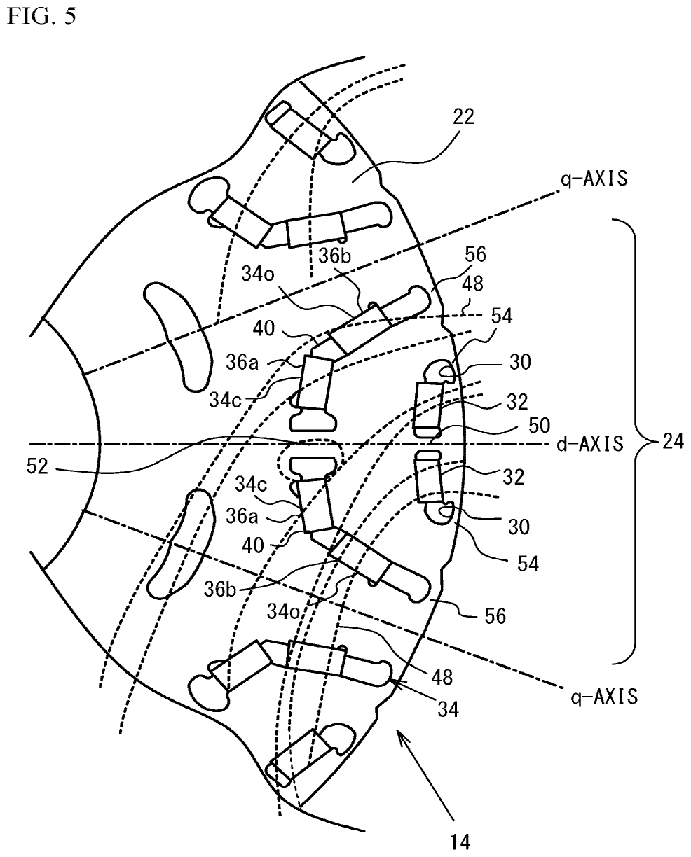

Next, the magnetic flux flowing through the rotor 14 of the present embodiment will be described with reference to FIG. 4 and FIG. 5. FIG. 4 is a schematic diagram illustrating main magnetic flux 46, and FIG. 5 is a schematic diagram illustrating magnet magnetic flux 48. The output torque of the permanent magnet synchronous rotary electric machine employed in the rotary electric machine 10 of the present embodiment is a combined torque of the reluctance torque and the magnet torque. The reluctance torque is a torque generated by an attractive force between the poles due to the rotating magnetic field of the stator 12 and the salient poles of the rotor 14. The reluctance torque increases as the amount of the main magnetic flux 46 flowing substantially in the circumferential direction across the d-axis increases in the rotor core 22. The magnet torque is a torque generated by attraction and repulsion between the poles of the rotating magnetic field of the stator 12 and the magnetic poles 24 of the rotor 14.

The magnet torque increases as the amount of the magnet magnetic flux 48 flowing through the outer magnets 32 and the inner magnets 36a and 36b increases in the rotor core 22. In the present embodiment, the first magnet mounting hole 30 and the second magnet mounting hole 34 are provided, and the outer magnet 32 and the inner magnets 36a and 36b are mounted in the respective magnet mounting holes to form a two layer structure. Therefore, it is possible to increase the number of permanent magnets and increase the total amount of the magnet magnetic flux 48 as compared with the case of a single-layer arrangement. In the present embodiment, two inner magnets 36a and 36b are mounted in one second magnet mounting hole 34. As a result, the number of permanent magnets can be increased and the magnet magnetic flux 48 can be increased as compared with the case in which only one permanent magnet is mounted in one second magnet mounting hole 34. By increasing the amount of the magnet magnetic flux 48, the output torque of the rotary electric machine 10 can also be improved. Leakage magnetic flux may be generated in which the magnet magnetic flux emitted from the north pole of one outer magnet 32 flows directly to the south pole of the one outer magnet 32. Similarly, leakage magnetic flux may be also generated in the inner magnets 36a and 36b. The leakage magnetic flux does not contribute to the output of the rotary electric machine 10. The leakage magnetic flux will be described in detail later.

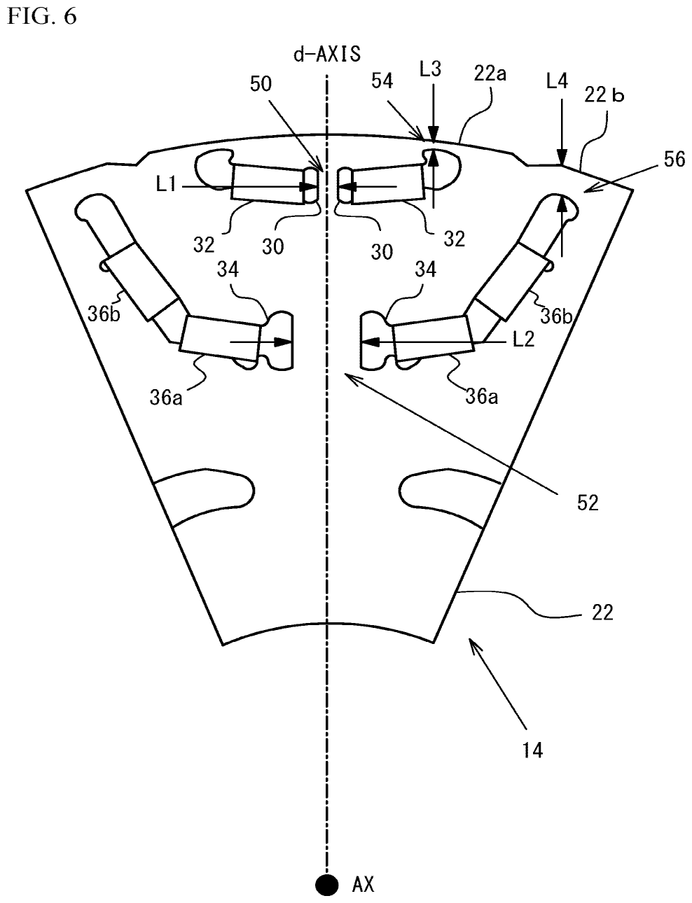

Here, the first bridge portion 50, the second bridge portion 52, a third bridge portion 54, and a fourth bridge portion 56 provided in the rotor core 22 will be described with reference to FIG. 6.

The first bridge portion 50 is provided between a pair of the first magnet mounting holes 30 adjacent to each other across the d-axis. The smallest width of the first bridge portion 50 is L1. In the present embodiment, the opposed side edges of the pair of the first magnet mounting holes 30 are parallel to the d-axis, but in the case that the opposed side edges are inclined with respect to the d-axis, the width of the part where the opposed side edges are closest to each other is defined as the smallest width L1.

The second bridge portion 52 is provided between a pair of the second magnet mounting holes 34 adjacent to each other across the d-axis. The smallest width of the second bridge portion 52 is L2. In the present embodiment, the opposed side edges closest to the d-axis of the pair of the second magnet mounting holes 34 are parallel to the d-axis. However, in the case that the opposed side edges are inclined with respect to the d-axis, the width of the part where the opposed side edges are closest to each other is defined as the smallest width L2.

The third bridge portion 54 is provided between a first outer peripheral surface 22a of the rotor core 22 and the first magnet mounting hole 30. The first outer peripheral surface 22a is an outer peripheral surface located further outward than the first magnet mounting hole 30 in the radial direction. The smallest width of the third bridge portion 54 is L3.

The fourth bridge portion 56 is provided between a second outer peripheral surface 22b of the rotor core 22 and the second magnet mounting hole 34. The second outer peripheral surface 22b is an outer peripheral surface located further outward than the second magnet mounting hole 34 in the radial direction. The smallest width of the fourth bridge portion 56 is IA.

Both the first outer peripheral surface 22a and the second outer peripheral surface 22b have arcs having the same radius centered on the rotation center axis AX. Both of the first outer peripheral surface 22a and the second outer peripheral surface 22b form a gap G with the stator 12 positioned outside the rotor 14 (see FIG. 1).

The smallest width L1 of the first bridge portion 50, the smallest width L2 of the second bridge portion 52, the smallest width L3 of the third bridge portion 54, and the smallest width IA of the fourth bridge portion 56 have a relationship represented by the following expression (1).

L3<L1<L4<L2 (1)

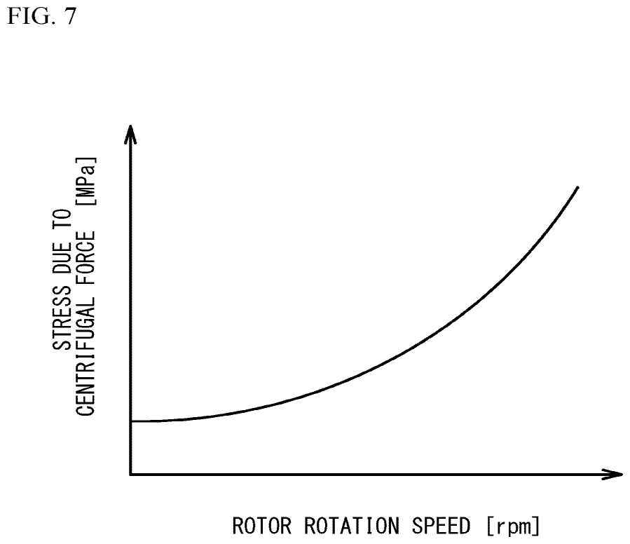

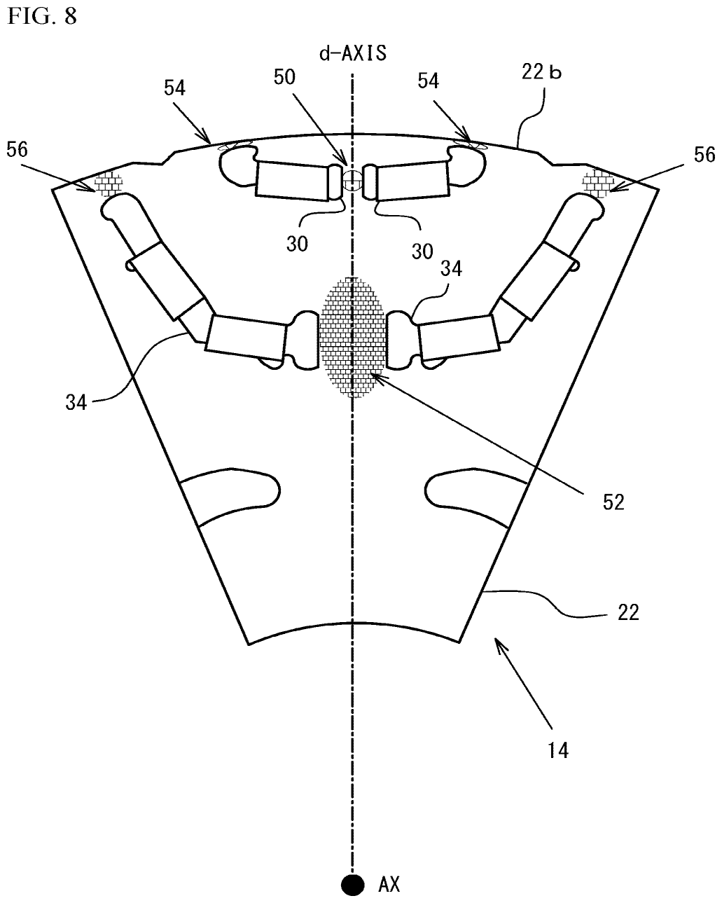

FIG. 7 presents a relationship between the rotor rotation speed and the maximum stress acting on the rotor core 22 due to the centrifugal force in the rotary electric machine 10. FIG. 7 suggests that the maximum stress acting on the rotor core 22 increases as the rotor rotation speed increases. Therefore, the maximum rotation speed of the rotor 14 is suppressed within a region in which the stress acting on the rotor core 22 is lower than the mechanical strength of the electromagnetic steel plate forming the rotor core 22. Since the magnitude of the stress is affected by the dimensions of the portion on which the centrifugal force acts, the maximum rotational speed of the rotor 14 can be improved by appropriately setting the dimensional relationship among the respective portions of the rotor core 22. Expression (1) is set from such a viewpoint, and specifically, is set based on the results of the stress analysis illustrated in FIG. 8.

In FIG. 8, the area where stress concentration occurs is hatched. The magnitude of the stress is represented by the density of hatching. The higher density of hatching indicates higher stress. According to FIG. 8, the stress acting on the third bridge portion 54 is the smallest, and the stress acting on the first bridge portion 50 is the second smallest. The stress acting on the fourth bridge portion 56 is the third smallest, and the stress acting on the second bridge portion 52 is largest.

Therefore, in the present embodiment, the smallest width L1 of the first bridge portion 50, the smallest width L2 of the second bridge portion 52, the smallest width L3 of the third bridge portions 54, and the smallest width L4 of the fourth bridge portions 56 in the rotor core 22 have the relationship presented in expression (1). That is, the smallest width L2 of the second bridge portions 52, which is the most severe portion in terms of stresses, is configured to be the largest, and the other bridge portions are also configured in accordance with the order of stresses.

The rotor 14 of the present embodiment can support high-speed rotation of the rotary electric machine 10 by satisfying the relationship defined by expression (1).

Since almost no stresses is applied to the third bridge portion 54, the smallest width L3 of the third bridge portion 54 can be made very thin as compared with the smallest widths of the other bridge portions. In other words, the smallest width L3 is only required to satisfy the relationship of L3≤L1.

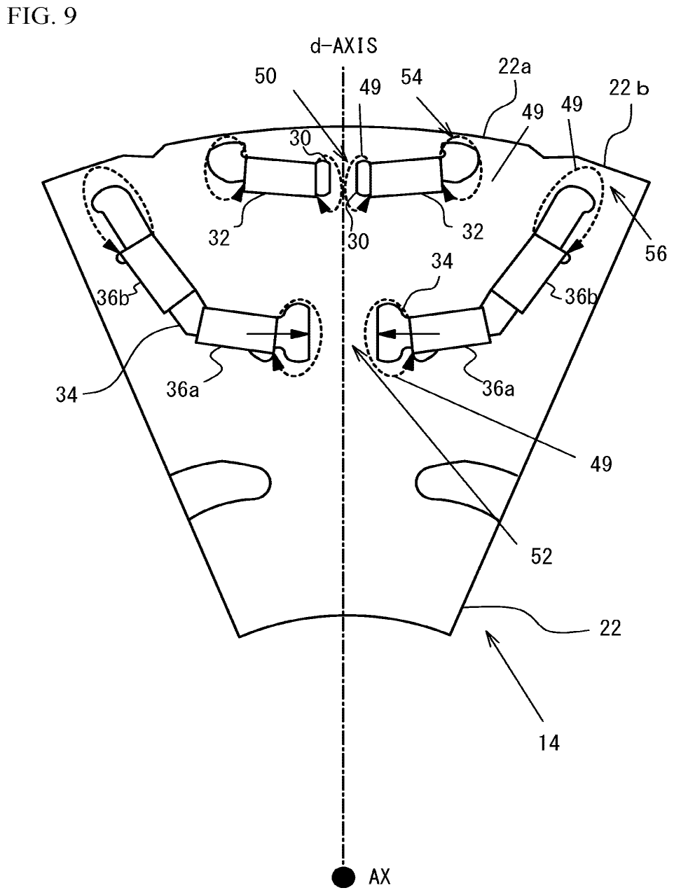

Next, with reference to FIG. 9 to FIG. 11, a ratio between the smallest width L2 of the second bridge portion 52 and the smallest width L1 of the first bridge portion 50 (the L2/L1 ratio) and a ratio between the smallest width L2 of the second bridge portion 52 and the smallest width L4 of the fourth bridge portion L4 (the L2/L4 ratio) will be described.

FIG. 9 schematically illustrates leakage magnetic flux 49. The leakage magnetic flux 49 is part of the magnet magnetic flux emitted from the north pole of the outer magnet 32, which is a permanent magnet, which directly flows to its own south pole, and part of the magnet magnetic flux emitted from the north poles of the inner magnets 36a, 36b, which directly flows to their own south poles. The leakage magnetic flux 49 increases in proportion to the width of each bridge portion. Since the leakage magnetic flux 49 does not contribute to the output of the rotary electric machine 10, as the leakage magnetic flux 49 increases, the output efficiency of the rotary electric machine 10 decreases. The rotor 14 of the present embodiment satisfies the relationship of expression (1). However, when the smallest width L2 of the second bridge portion 52, which is the most severe portion in terms of stress, is increased, the leakage magnetic flux 49 increases accordingly, and there is a concern that the output efficiency of the rotary electric machine 10 will decrease.

Therefore, the ranges of the L2/L1 ratio and the L2/L4 ratio are set so that the stress is within the mechanical strength of the electromagnetic steel plate constituting the rotor core 22 and the rotary electric machine 10 can operate in a high-output and low-loss state. The reason why the smallest width L3 of the third bridge portion 54 is not taken into consideration is that, as described above, almost no stresses acts on the third bridge portion 54, and the smallest width L3 of the third bridge portion 54 can be made very thin compared with the smallest widths of the other bridge portions.

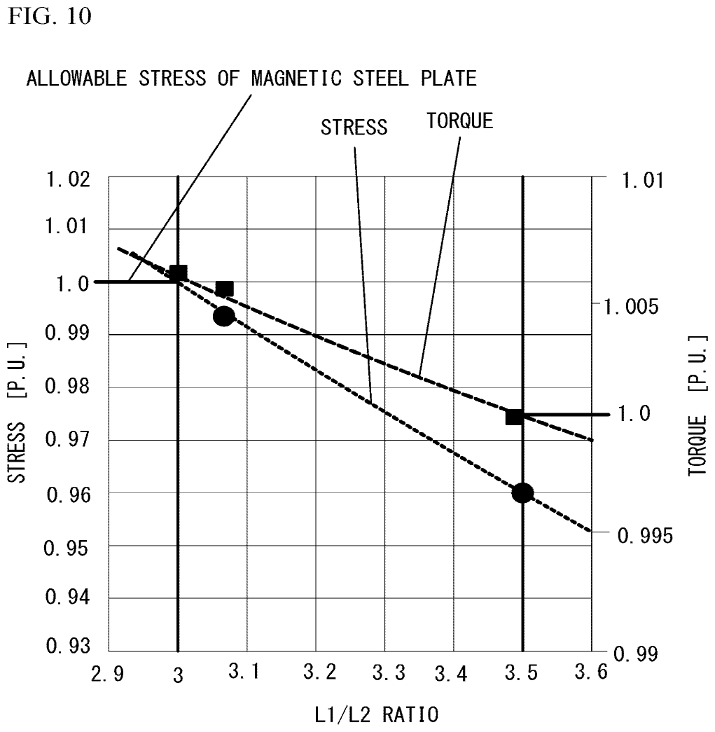

First, the L2/L1 ratio will be described. In FIG. 10, stress [P.U.] (maximum stress in the rotor core 22) is set on one vertical axis, and torque [P.U.] (maximum torque generated by the rotary electric machine 10) is set on the other vertical axis.

In FIG. 10, the stress [P.U.]=1.0 indicates the allowable stress of the electromagnetic steel sheet, and when the stress [P.U.] becomes larger than 1.0, the maximum stress acting on the rotor core 22 exceeds the mechanical strength of the electromagnetic steel plate, and the rotor core 22 is damaged. On the other hand, when the stress [P.U.] is 1.0 or less, the stress becomes equal to or less than the allowable stress of the electromagnetic steel sheet, and the rotary electric machine 10 can be operated without damaging the rotor core 22. The stress [P. U.] decreases as the L2/L1 ratio increases, that is, as the smallest width L2 increases. When the L2/L1 ratio is 3.0 or greater, the stress [P. U.] can be 1.0 or less.

On the other hand, the torque [P.U.]=1.0 indicates the required torque of the rotary electric machine 10, and when the torque [P.U.] becomes lower than 1.0, the rotary electric machine 10 cannot output the required torque. On the other hand, when the torque [P.U.] is 1.0 or greater, the rotary electric machine 10 can output the required torque. The torque [P.U.] decreases as the L2/L1 ratio increases, that is, as the smallest width L2 increases. When the L2/L1 ratio becomes larger than 3.5, the torque [P.U.] becomes smaller than 1.0. This is because the leakage magnetic flux 49 increases as the smallest width L2 increases, and the output efficiency of the rotary electric machine 10 thereby decreases.

Therefore, the rotor 14 of the present embodiment has a relationship represented by the following expression (2).

3.0≤L2/L1≤3.5 (2)

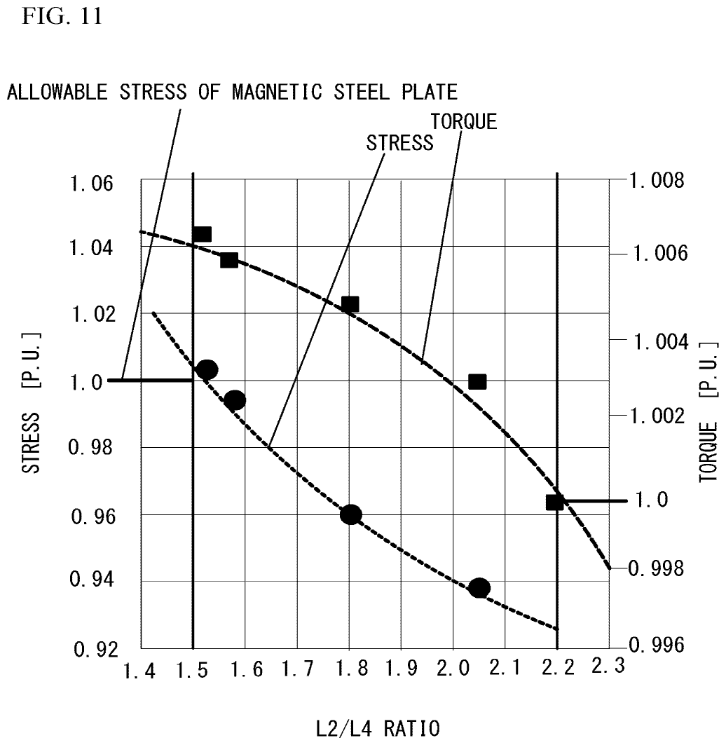

Next, the L2/L4 ratio will be described. As illustrated in FIG. 11, similarly to FIG. 10, stress [P.U.] (maximum stress in the rotor core 22) is set on one vertical axis, and torque [P.U.] (maximum torque generated by the rotary electric machine 10) is set on the other vertical axis.

In FIG. 11, the stress [P.U.]=1.0 indicates the allowable stress of the electromagnetic steel plate, and when the stress [P.U.] becomes larger than 1.0, the maximum stress acting on the rotor core 22 exceeds the mechanical strength of the electromagnetic steel plate, and the rotor core 22 is damaged. On the other hand, when the stress [P.U.] is 1.0 or less, the stress becomes equal to or less than the allowable stress of the electromagnetic steel plate, and the rotary electric machine 10 can be operated without damaging the rotor core 22. The stress [P. U.] decreases as the L2/L4 ratio increases, that is, as the smallest width L2 increases. When the L2/L4 ratio is 1.5 or greater, the stress [P. U.] can be made to be 1.0 or less.

On the other hand, the torque [P.U.]=1.0 indicates the required torque of the rotary electric machine 10, and when the torque [P.U.] becomes lower than 1.0, the rotary electric machine 10 cannot output the required torque. On the other hand, when the torque [P.U.] is 1.0 or greater, the rotary electric machine 10 can output the required torque. The torque [P.U.] decreases as the L2/L4 ratio increases, that is, as the smallest width L2 increases. When the L2/L4 ratio becomes larger than 2.2, the torque [P.U.] becomes smaller than 1.0. This is because the leakage magnetic flux 49 increases as the smallest width L2 increases, and the output efficiency of the rotary electric machine 10 thereby decreases.

Therefore, the rotor 14 of the present embodiment has a relationship represented by the following expression (3).

1.5≤L2/L4≤2.2 (3)

As described above, the rotor 14 of the present embodiment can obtain a high output without losing the magnetic force because an increase in the leakage magnetic flux 49 is reduced while the mechanical strength of the rotor core 22 is ensured. The rotor 14 can support high-speed rotation of the rotary electric machine 10 because the mechanical strength of the rotor core 22 is ensured.

The magnitude of the centrifugal force applied to one electromagnetic steel plate forming the rotor core 22 is the same even when the length of the rotor core 22 in the axial direction changes. Therefore, as long as the rotor core 22 has a shape that satisfies the above-described conditions when viewed in the axial direction, the length of the rotor core 22 in the axial direction may be different and may be set in various ways. In other words, the length of the rotor core 22 in the axial direction can be appropriately set, but the shape of the rotor core 22 when viewed in the axial direction is required to satisfy the above-described conditions.

### Variations

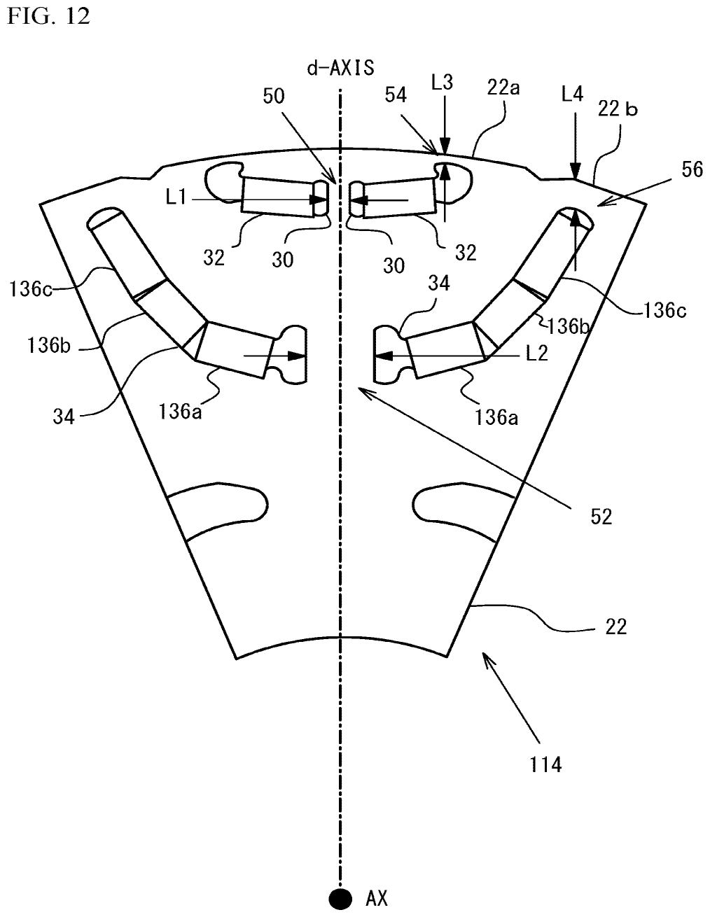

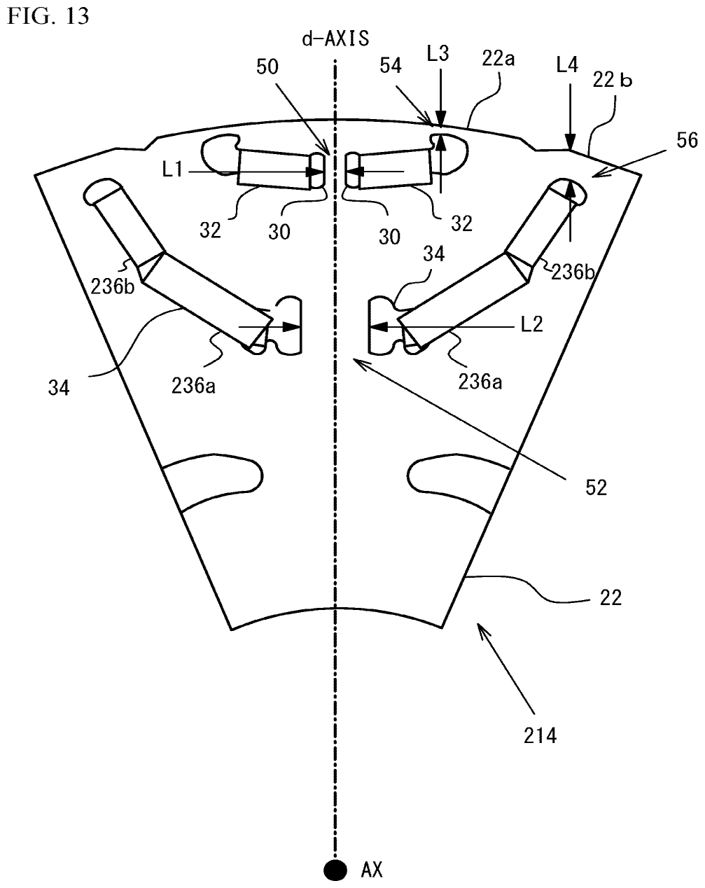

Next, variations will be described with reference to FIG. 12 and FIG. 13. In the following description, differences between each variation and the rotor 14 described in the embodiment will be mainly described, and components common to those of the rotor 14 of the embodiment are denoted by the same reference numerals in the drawings, and detailed description thereof will be omitted.

<First Variation>

As illustrated in FIG. 12, a rotor 114 of a first variation includes inner magnets 136a, 136b, and 136c instead of the inner magnets 36a and 36b disposed in the second magnet mounting hole 34 included in the rotor 14 of the embodiment.

In the rotor 114 having such a configuration, the relationship among the smallest width L1 of the first bridge portion 50, the smallest width L2 of the second bridge portion 52, the smallest widths L3 of the third bridge portion 54, and the smallest width L4 of the fourth bridge portion 56 is set so as to satisfy the above expression (1). This configuration ensures the mechanical strength of the rotor 114, and allows the rotor 114 to support high-speed rotation of the rotary electric machine 10. Further, by satisfying the relationships of expression (2) and expression (3), it is possible to suppress an increase in the leakage magnetic flux 49 while ensuring the mechanical strength of the rotor core 22, and to obtain a high output without losing the magnetic force.

<Second Variation>

As illustrated in FIG. 13, a rotor 214 of a second variation includes inner magnets 236a and 236b instead of the inner magnets 36a and 36b included in the rotor 14 of the embodiment. The inner magnet 236a and the inner magnet 236b have different dimensions when viewed in the axial direction.

In the rotor 214 having such a configuration, the relationship among the smallest width L1 of the first bridge portion 50, the smallest width L2 of the second bridge portion 52, the smallest width L3 of the third bridge portion 54, and the smallest width L4 of the fourth bridge portion 56 is set so as to satisfy the above expression (1). This configuration ensures the mechanical strength of the rotor 114, and allows the rotor 114 to support high-speed rotation of the rotary electric machine 10. Further, by satisfying the relationships of expression (2) and expression (3), it is possible to suppress an increase in the leakage magnetic flux 49 while ensuring the mechanical strength of the rotor core 22, and to obtain a high output without losing the magnetic force.

Although some embodiments of the present invention have been described in detail, the present invention is not limited to the specific embodiments but may be varied or changed within the scope of the present invention as claimed.

What is claimed is:

1. A rotor that is rotatably and concentrically disposed inside a stator and in which a plurality of magnetic poles arranged in a circumferential direction with a q-axis interposed therebetween are formed, the rotor comprising:
a rotor core in which magnet mounting holes, which are provided in a plurality of layers along a radial direction and are arranged symmetrically in the circumferential direction about a d-axis, are formed for each of the magnetic poles; and
magnets disposed in the magnet mounting holes, respectively,
wherein the rotor core includes a first bridge portion, a second bridge portion, a third bridge portion, and a fourth bridge portion, where the first bridge portion is provided between a pair of first magnet mounting holes, which are included in the magnet mounting holes and are adjacent to each other across the d-axis, the second bridge portion is provided between a pair of second magnet mounting holes, which are located further inward than the pair of first magnet mounting holes in the radial direction and are adjacent to each other across the d-axis, the third bridge portion is provided between an outer peripheral surface of the rotor core and the first magnet mounting hole, and the fourth bridge portion is provided between the outer peripheral surface of the rotor core and the second magnet mounting hole, and
wherein when a smallest width of the first bridge portion is represented by L1, a smallest width of the second bridge portion is represented by L2, a smallest width of the third bridge portion is represented by L3, and a smallest width of the fourth bridge portion is represented by L4, a relationship of
L3<L1<L4<L2
is satisfied.

2. The rotor according to claim 1, wherein the rotor core further satisfies a relationship of 3.0≤L2/L1≤3.5.

3. The rotor according to claim 1, wherein the rotor core further satisfies a relationship of 1.5≤L2/L4≤2.2.

4. The rotor according to claim 1, wherein in one of the magnetic poles, the first magnet mounting holes are provided symmetrically in the circumferential direction about the d-axis across the first bridge portion through which the d-axis passes, and at least one of the magnets is disposed in each of the first mounting holes.

5. The rotor according to claim 1, wherein in one of the magnetic poles, the second magnet mounting holes are provided symmetrically in the circumferential direction about the d-axis across the second bridge portion through which the d-axis passes, and at least one of the magnets is disposed in each of the second magnet mounting holes.

6. The rotor according to claim 5, wherein two or more of the magnets are disposed in each of the second magnet mounting holes.

7. The rotor according to claim 5, wherein magnets having different dimensions when viewed in an axial direction are disposed in the second magnet mounting holes.

8. The rotor according to claim 1, wherein in one of the magnetic poles, each of the second magnet mounting holes has a polygonal line shape having one or more bending points when viewed in the axial direction, and at least one of the magnets is provided in each of regions on both sides of the bending points.

9. The rotor according to claim 1, wherein the magnets have a curved shape when viewed in the axial direction.

10. A rotary electric machine, comprising the rotor according to claim 1.
